(19) United States
(12) Patent Application Publication
(10) Pub. No.: US 2004/0003834 A1
(43) Pub. Date: Jan. 8, 2004

(54) Modular carwash assembly

(76) Inventor: Bruce Arnett JR., Flowery Branch, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/423,532

(22) Filed: Apr. 25, 2003

Related U.S. Application Data
(60) Provisional application No. 60/377,509, filed on May 1, 2002.

(51) Int. Cl. B08B 3/00

(52) U.S. Cl. 134/115 R; 134/123; 134/172; 134/174; 52/741.1

(57) ABSTRACT

A prefabricated modular carwash assembly includes a carwash module and an equipment module that are easily constructed and transported at a predetermined building site. Alternatively the components of the assembly may also be erected at a predetermined location and transported to the building site. The carwash and equipment modules are easily fabricated and connected to each other. The carwash module includes a skeletal system secured on a flooring, wherein the skeletal system supports the carwash equipment. The equipment module is constructed like the carwash module, and is positioned proximate the carwash module at the building site. The equipment module includes washing and drying components such as a water pumping station and an air compressor for generating a stream of air to dry the vehicle.

The present application claims priority from U.S. Provisional Patent Application No. 60/377,509, filed on May 1, 2002.

### BACKGROUND OF THE INVENTION

1. Field of the Invention

The present invention relates generally to carwashes and, more particularly, to modular prefabricated carwashes that may be easily transported to a desired site complete with equipment installed and tested.

2. Description of the Related Art

Many people have become accustomed to the convenience of using a carwash. Carwashes are frequently installed at gas stations whereby drivers can purchase gas and at the same time purchase a carwash. For the drivers, the combination of getting gas and a carwash at the same location is a great convenience. For the owners of the gas stations or convenience stores, the carwash presents an additional opportunity to increase sales and revenue. From a competitive aspect, many gas stations and convenience stores want a carwash in order to lure additional customers to their stores.

The construction of carwashes normally requires expertise in several different areas. After a suitable location has been secured, the floor plan of the building must be laid and the car washing equipment position determined. The building generally consists of a tunnel in which the car washing equipment is located and where the car is washed and a mechanical room where the controls for the equipment are kept. The distribution and delivery of power and supplies to such equipment must then be designed. Since each car wash building may be slightly different, each layout for the equipment is also slightly different, and the design of a system for the distribution and delivery of supplies for the equipment previously required individual attention for each carwash. The design and installation of such a system requires considerable expertise in the areas of plumbing, electricity and hydraulics. Skilled plumbers and electricians employed in the construction must also be specifically experienced in carwash equipment.

Before the present invention, the building of a carwash in a remote location required a considerable expenditure of time and effort. It was required that the builder travel to the location in order to contract skilled electricians, plumbers, and equipment installation personnel in order to ensure their availability as necessary for the installation.

Once these experienced technicians had been scheduled, it was required that they design, and subsequently install chemical, electrical and hydraulic distribution systems to deliver supplies to the equipment to be used in the carwash. This required a large expenditure of time and concerted effort by these skilled technicians, resulting in a high cost to the builder.

After installation of the equipment and supply distribution and delivery systems, these systems were subject to inspection and approval by local officials. In view of the fact that the systems were designed and built specifically for the single carwash in which they were located, these inspections were often rigorous. Occasionally parts of the systems might need to be replaced in order to meet municipal codes. Additionally, the entire design and installation would have to be supervised by representatives of the builder in order to ensure the system met the builder's standards.

Other problems with prior art carwash supply distribution systems include a difficulty in servicing defective or worn out parts such as valves or solenoids because they may be permanently installed as parts of the plumbing. Additionally these valves or solenoids may be located in the carwash tunnel, increasing the deleterious exposure to chemicals and water used in the car washing process.

The plumbing, hydraulic and electrical lines for conventional carwashes normally require that they be secured to the walls of the carwash tunnel for support. This greatly hinders the task of cleaning the walls of the tunnel. Dirt and grime are thus more likely to accumulate and associated problems arise within the carwash tunnel.

If the supplies of chemicals are also located in the carwash tunnel, the tunnel itself might need to be heated, as some of the chemicals would suffer adverse effects from low temperatures. If this were the case an additional problem arises since the viscosity of the concentrated chemicals to be used in the carwash increases substantially at low temperatures. This causes problems in the dilution and mixing of the chemicals.

Oftentimes, a carwash can be installed on-site in approximately three months. During this time, the owner of the carwash will contact with a general contractor who oversees construction of the carwash. The general contractor coordinates and schedules the various laborers involved in constructing the carwash. During a first phase, the necessary groundwork is performed, including laying the concrete and running a drainage pipe to a sewer system. Constructing the carwash involves erecting the walls of the tunnel and also constructing the equipment room with suitable access to the outside. The washing unit itself is then installed within the tunnel. This washing unit may comprise an overhead gantry system in which case the washing unit is placed upon a set of support beams. The washing unit may comprise other types of units, such as a floor-mounted gantry system.

During the construction of a prior art carwash, plumbers are needed for the running of the drainage pipe, connecting the carwash to a water supply, and for the various interconnection within the carwash itself. Electricians are also needed for the power and control wiring. Carpenters or other such laborers are needed to erect the walls and ceilings of the buildings and additional laborers needed for doing the necessary ground preparation work, laying the concrete, and perhaps for erecting an exterior elevation, such as bricks or stucco.

Thus, as can be appreciated by those skilled in the art, the construction of a carwash requires the careful coordination of a large number of skilled craftspersons. Because the construction of a carwash requires the assistance of so many people, the failure of any particular person or group of people to satisfactorily perform their tasks can have deleterious effects on the carwash. Oftentimes, problems arise during the construction of the carwash and the general contractor is forced to determine which sub-contractor is at fault, with the sub-contractors typically accusing each other of the problems in the construction of the carwash. Also, the laborers may not have experience in constructing a carwash and, as a result, the quality of their work may be sub-standard. For example, an electrician may have experience with power distribution but may not have sufficient experience with control wiring within a carwash to do a quality job on a that portion of the job. In light of all these variables in the workforce, the quality and installation of carwashes across the country is not uniform.

In addition to dealing with likely problems or obstacles in the construction of the carwash, the future owner of the carwash must also endure long delays before the carwash is operational. The typical time for constructing a carwash is on the order of three months. During this time, the future owner must cope with the nuisance of having a worksite on its premises, which could interfere with the ability to carry on normal operations at the business. This long delay also presents a financial burden to the future owner because of the financial resources tied up in the construction and the wait of three or so months before the carwash can generate any revenue. Thus, the future owner of the carwash has a great incentive to expedite construction of the carwash, not only to minimize the nuisance but also to expedite when the carwash can begin to generate revenue.

This pressure to expedite construction, however, may unnecessarily hasten work on the carwash and cause the laborers to sacrifice quality in order to meet shortened deadlines. The future carwash owner must perform a careful balancing between pushing the general contractor and sub-contractors to finish the job with the desire to have a quality constructed carwash. Any sacrifice in the quality may only cause the carwash owner to incur greater repairs down the road and an additional nuisance and expense associated with those repairs.

Some attempts have been made to simplify the construction of a carwash. For example, some carwash owners, especially gas stations, have a standard design for the carwash. The carwashes therefore may have the same dimensions, the same walls and ceilings, and same equipment installed within the carwash. By adopting a single design, the installation and construction of a carwash can become more routine and thus less prone to unforeseen problems. Another approach is to prepare assemblies of components which are then installed within the carwash structure. For instance, U.S. Pat. No. 4,955,405 describes a “Prefabricated Car Wash Distribution And Delivery System And Method” wherein a raceway is prefabricated with lines and hoses and this assembly is transported to the car wash for installation. By fabricating the raceway as a preassembled structure, the work that is needed on site for making the necessary interconnections and wiring between the equipment is reduced. While this patent addresses some of the problems mentioned above, the construction of a carwash still requires the assistance of various skilled laborers, including electricians and plumbers.

A need exists for systems and methods for constructing carwashes that address the above-mentioned problems. For example, a need exists for systems and methods for constructing a carwash that is consistently constructed according to high quality standards and can be installed in a minimal amount of time. As mentioned above, these two desires run counter to each other since hastening the construction of a carwash often results in sacrificing quality.

### SUMMARY OF THE INVENTION

An object of the present invention is to provide a modular carwash for simple construction on site.

A further object of the present invention is to provide a prefabricated modular carwash assembly to reduce the number of technicians required for installation at a carwash location.

Yet a further object of the present invention is to provide a fully assembled modular carwash that can be constructed in a short period of time.

The modular carwash assembly of the present invention is modular in design such that it may be transported to any desired location.

The modular carwash assembly of the present invention includes a carwash module and an equipment module that are easily installed at a work site. Alternatively these components may be erected at a predetermined location and transported to the building site. In either case, the carwash module and equipment module are easily constructed and easily connected to each other.

The carwash module includes a skeletal system secured on a sloped flooring, wherein the skeletal system is able to support the carwash equipment. The skeletal system includes a series of columns, with pairs of columns being connected by crossarms. The skeletal system thereby is able to support a carriage that is supported on two carriage rails mounted between two crossarms. The carriage supports a pair of spray arms that direct water and cleaning fluid towards a vehicle positioned within the carwash module.

The equipment module is constructed in substantially the same manner as the carwash module, with the equipment module being positioned proximate the carwash module at the building site. The equipment module includes washing and drying components such as a pumping station for delivering water and fluid to the spray arms and an air compressor for generating a stream of air to dry the vehicle after washing. Additionally, the equipment module may include water purifiers, water softeners and related equipment.

The equipment module is therefore designed to be easily connected to the carwash module. More specifically, the carwash equipment mounted in the carwash module is easily connected with the carwash equipment housed in the equipment module, such that the connections can be completed in a quick fashion without requiring the work of plumbers, electricians, and other specialists.

### BRIEF DESCRIPTION OF THE DRAWINGS

A modular carwash embodying the features of the present invention is depicted in the accompanying drawing which form a portion of this disclosure and wherein:

FIG. 1A is a front end view of the modular carwash assembly of the present invention;

FIG. 1B is a rear end view of the modular carwash assembly of the present invention;

FIG. 1C is a first side view of the modular carwash assembly of the present invention;

FIG. 1D is a second side view of the modular carwash assembly of the present invention;

FIG. 2 is a top plan view of the modular carwash assembly of the present invention;

FIG. 3 is a sectional top view of the modular carwash assembly of the present invention as illustrated in FIG. 2;

FIG. 4 is a schematic view of the modular carwash assembly of the present invention as illustrated in FIG. 3;

FIG. 5 is a partially exploded view of the carwash equipment used in the modular carwash assembly of the present invention;

FIG. 6 is a top plan view of the carwash equipment attached to the building skeleton;

FIG. 7 is an end view of the modular carwash assembly of the present invention;

FIG. 8A is a sectional view of the first side of the modular carwash assembly;

FIG. 8B is a sectional view of the second side of the modular carwash assembly; and

FIG. 9 is a sectional view of the flooring of the present invention.

### DETAILED DESCRIPTION OF THE PREFERRED EMBODIMENT

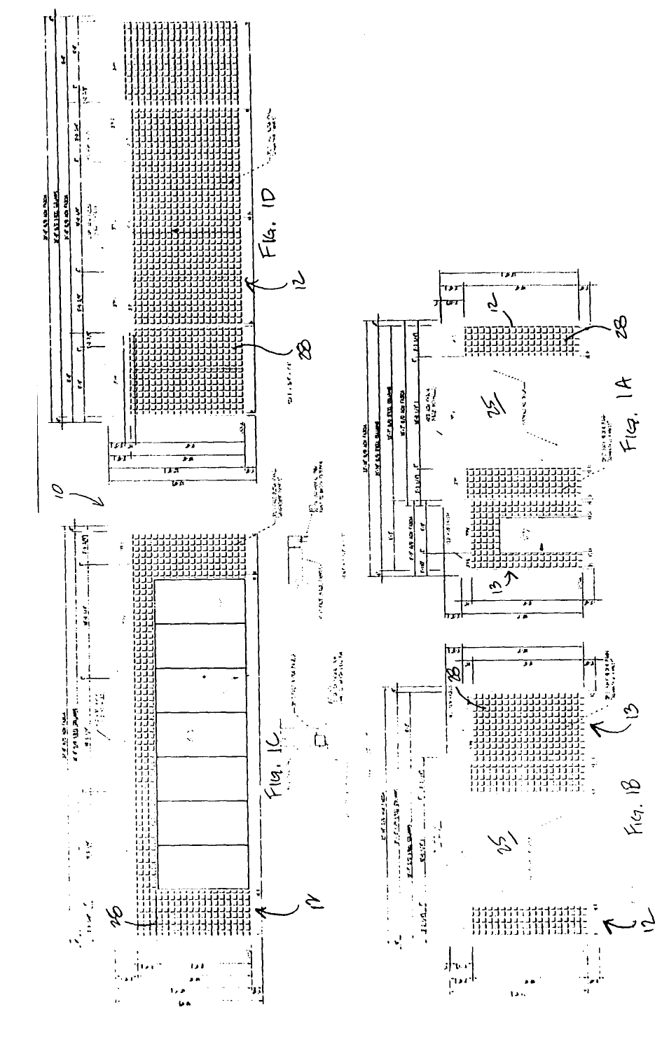

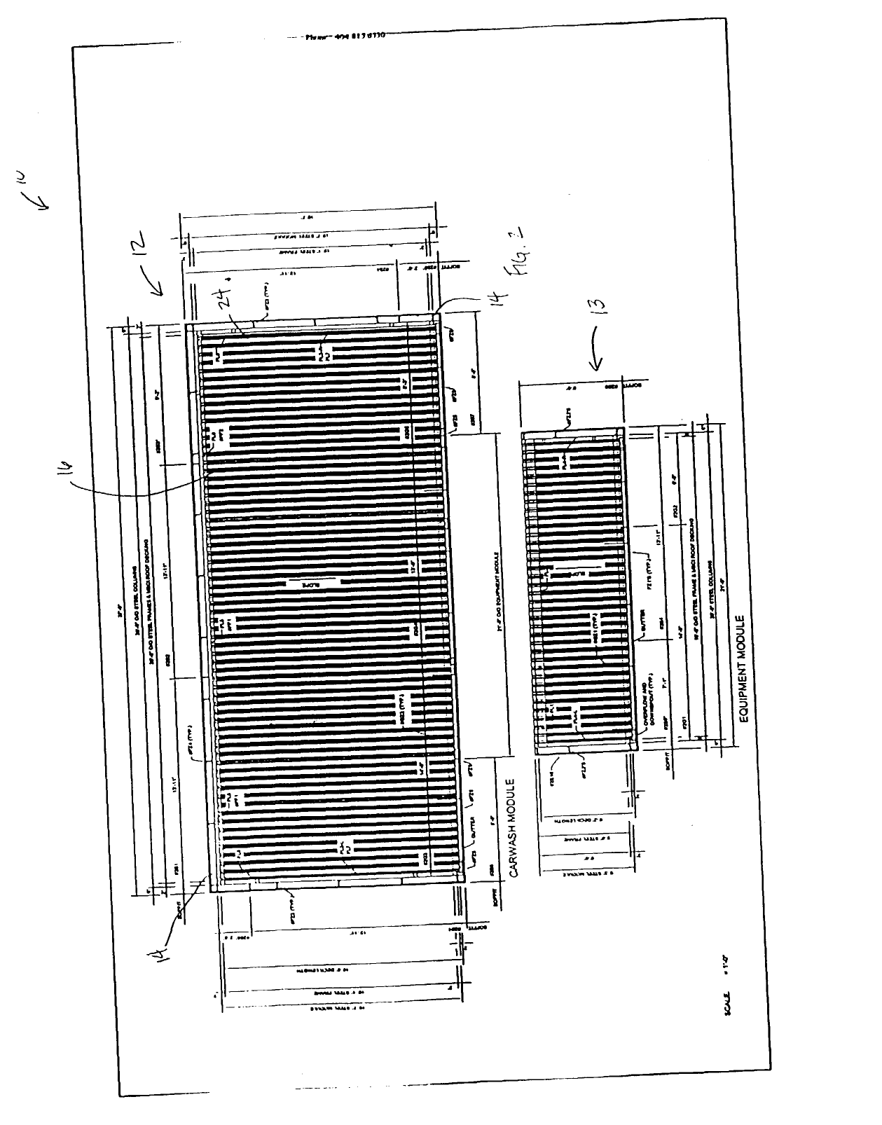

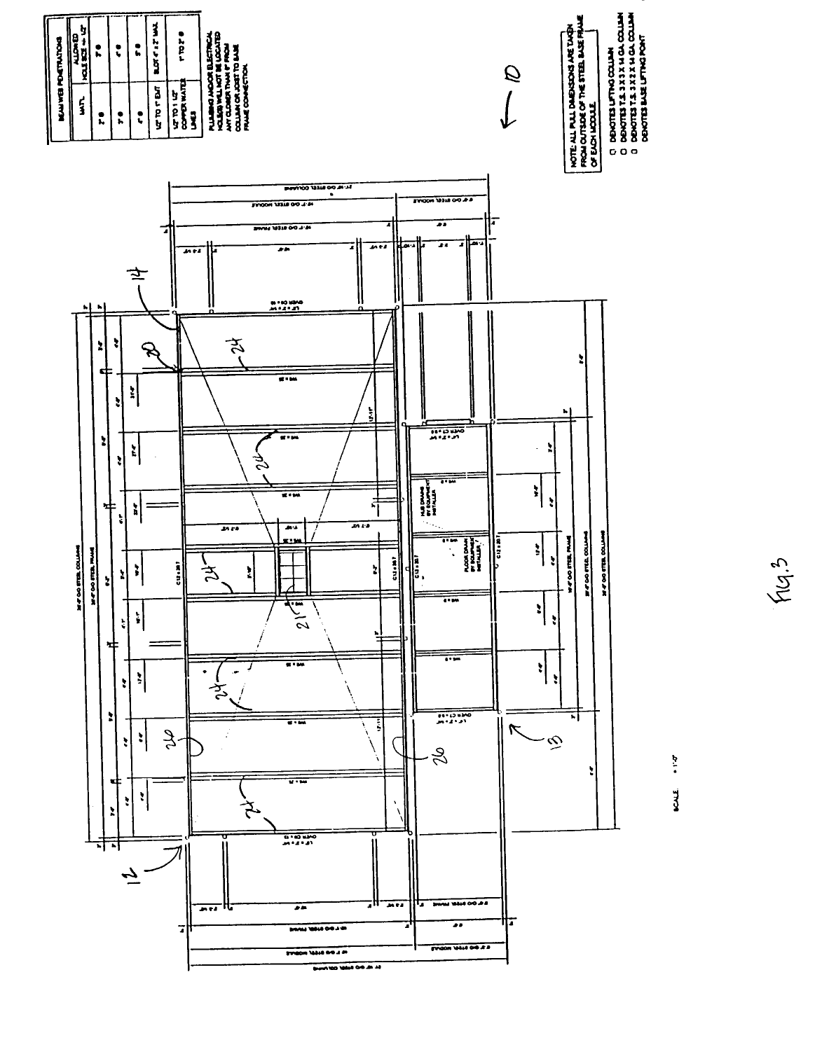

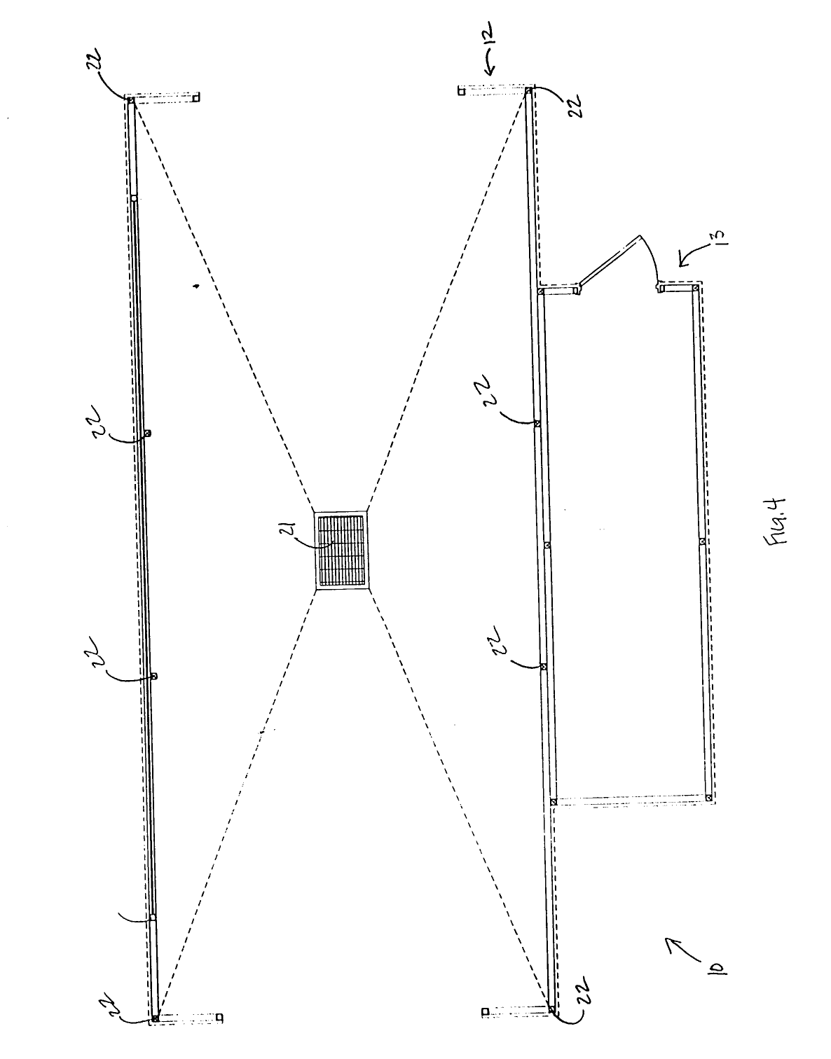

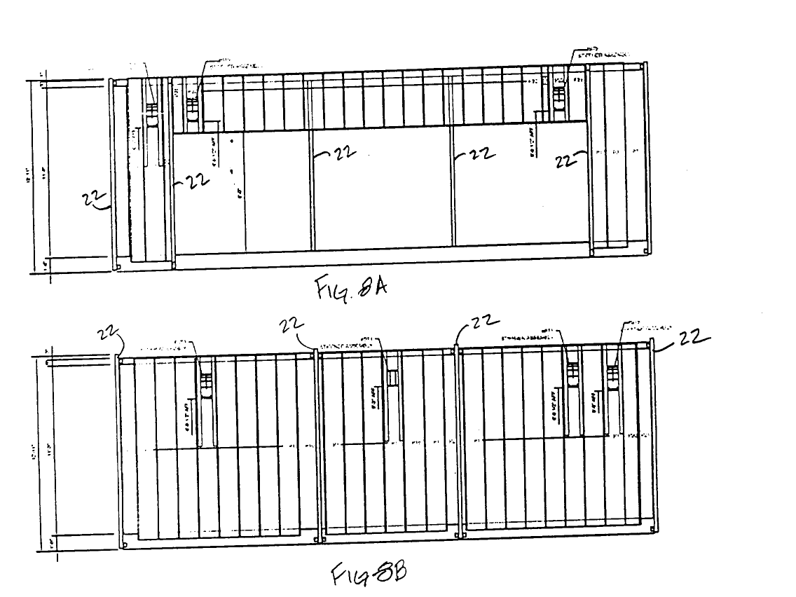

Reference will now be made in detail to preferred embodiments of the invention, non-limiting examples of which are illustrated in accompanying FIGS. 1 through 9. These figures illustrate just one example as to how a carwash assembly 10 according to a preferred embodiment of the present invention may be manufactured. Elevations may be customized for a location (brick, stucco, ACM and split face block) rooflines also. It should be understood that the drawings do not limit the invention to the precise embodiment disclosed; rather, carwashes according to the invention may have other dimensions or made of other materials.

Overview

Systems and methods according to preferred embodiments of the present invention address the problems mentioned in the Background section of this application by providing a modular carwash assembly 10 that may be constructed in an expedited manner and prefabricated to be shipped to a desired location. In particular, the modular carwash assembly 10 of the present invention includes a carwash module 12 and an equipment module 13, wherein the carwash equipment 30 is installed in both modules 12, 13. The carwash module 12 includes a series of walls 14, a ceiling 16, and a sloping floor 18. By prefabricating the entire carwash assembly 10 or substantially all of the carwash assembly 10, both the carwash module 12 and the equipment module 13 can be transported to the site for the establishment of the carwash assembly 10, installed, and ready to use in a minimal amount of time. For example, in contrast to the typical construction cycle of three months or more, the modular carwash assembly 10 can be installed on the building site and ready to use in as little as one or two days. Further advantages and benefits of the carwash assembly 10 according to the present invention will be apparent from the description below.

Structure

Significantly, the carwash module 12 and equipment module 13 of the modular carwash assembly 10 are such that they can be shipped either with all of the necessary carwash equipment 30 installed or the various components of the modules 12, 13 can be transported to the building site and the carwash equipment 30 then installed. An important feature of the carwash module 12 is that the walls 14 of the carwash assembly 10 are constructed with sufficient strength to support the weight of the carwash equipment 30. By mounting a portion of the carwash equipment 30 directly to the walls 14 of the carwash module 12, the carwash assembly 10 according to the invention avoids the need for additional support beams or other similar structure for supporting the weight of overhead washing units.

In the preferred embodiment, both modules 12, 13 include a skeletal system 20, which will include a series of columns, advantageously steel columns, 22 and crossarms, advantageously steel crossarms, 24. With the carwash module 12, the inner surface of the columns 22 advantageously are engaged by an impervious protective layer 26, while the outer surface of the steel columns 22 are engaged by an exterior layer 28. This skeletal system 20 can therefore reduce the width of the carwash assembly 10 as compared to conventional carwashes, and more importantly can reduce the height of the carwash assembly 10. With conventional carwash designs, the walls are made of metal paneling and must be constructed high enough so that the overhead washing unit and support structure can be received within the carwash. In doing so, the conventional carwash cannot have its structure prefabricated since the height of the carwash is too high to pass underneath bridges during transit on the highway. In contrast, the carwash assembly 10 according to the preferred embodiment of the present invention enables the carwash module 12 to be prefabricated and shipped preassembled to the desired site for placement, and to be within such height restrictions.

Another advantage of the carwash assembly 10 according to preferred embodiments of the present invention results from the use of the impervious protective layer 26, which surrounds a tunnel 25. During the fabrication of the carwash module 12, the protective layer 26 is connected with the skeletal system 20 to form the tunnel 25 of the carwash assembly 10. The protective layer 26 will thereby protect the carwash module 12 from the corrosive environment created during use of the carwash assembly 10. This corrosive environment is created through the use of the various chemicals used and applied to the vehicle being cleaned as well as to the ambient environmental conditions. The protective layer 26 is preferably impervious to these chemicals and to the exposure to environmental conditions to protect the skeletal system 20. Some examples of suitable impervious protective layers 22 include fiberglass, polyurethane or like coating, which may be applied within the tunnel 25. It should be noted that the protective layer 26 may be sprayed onto an interior of the tunnel 25.

The ceiling 16 of the carwash assembly 10 according to a preferred embodiment of the invention can accommodate any suitable elevation to allow the desired vehicular traffic through the carwash module 12. Moreover, the exterior layer 28 can be formed of a variety of desired materials, such as thin set brick, panels, stucco, and so forth, as well as any desired shape, such as a gabled roof, flat roof, windows, and the like. Thus, carwashes 10 according to the preferred embodiment of the invention are not limited in any set of dimensions, but may be compacted in size as needed for a particular location.

Carwash Equipment

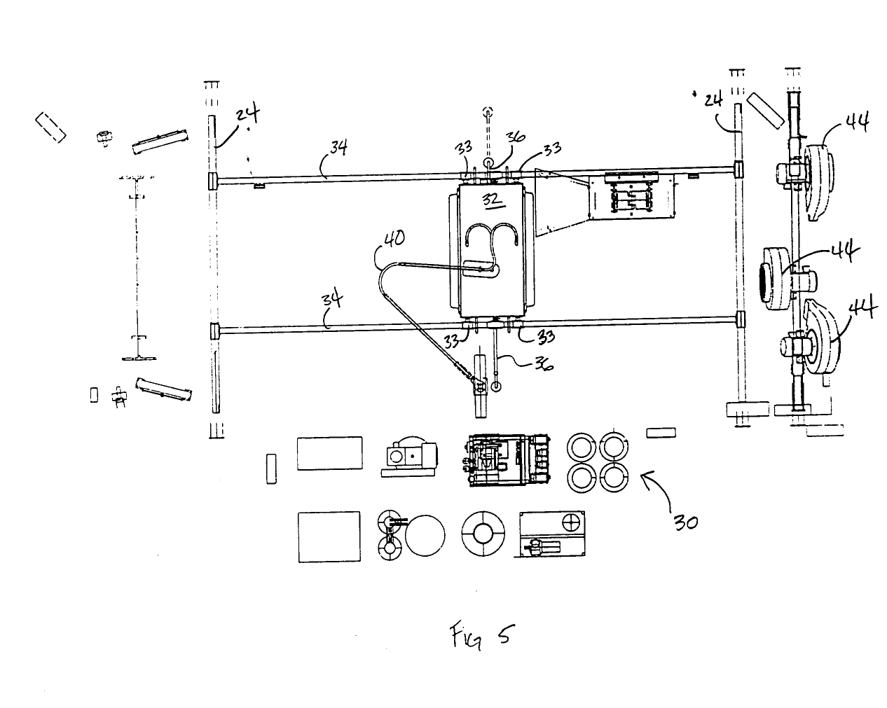

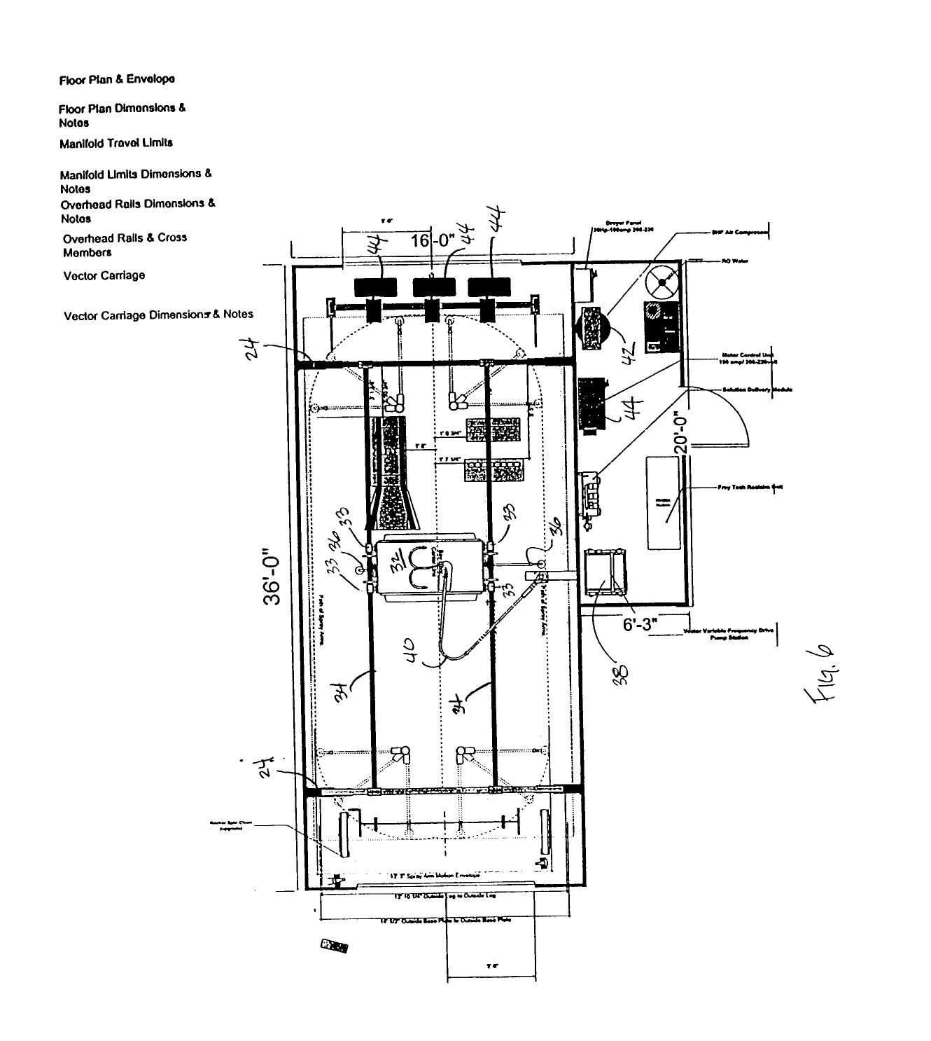

Looking to FIGS. 5 and 6, the carwash equipment 30 is housed in both the carwash module 12 and the equipment module 13. The preferred embodiment of the carwash equipment 30 will include a carriage 32 that is mounted on a pair of carriage rails 34 using a set of carriage wheels 33. The carriage wheels 33 are thereby driven by a carriage motor (not illustrated) for the carriage 32 to traverse the carwash tunnel 25. At least one spray arm 36 is rotatably connected to the carriage 32 such that each spray arm 36 may swivel about the vehicle positioned in the tunnel 25. The spray arm 36 is connected to a fluid pumping station 38 located in the equipment module 13 via a spray conduit 40. As a result, water is provided for soaking the vehicle. The fluid pumping stating 38 is housed in the equipment module 13, such that the spray conduit 40 is used to connect between the carwash module 12 and the equipment module 13.

In addition to the fluid pumping station 38, other components of the carwash equipment 30 are protectively stored in the equipment module 13. For example, a motor control unit 44 is stored in the equipment module 13 and connected to the carriage 32 to control transverse movement of the carriage 32 within the carwash module 12. Additionally, the carwash assembly 10 includes means for drying the vehicle after it has been washed. The drying means may include an air compressor 42 that is stored in the equipment module 13 and connected to air vents 44 in the carwash module 12 via an air conduit. As a result, a stream of air is generated to be directed toward to the center of the carwash module 12 toward the vehicle to force water from the vehicle.

In addition to these components, the carwash assembly 10 may include various accessories to aid in cleaning vehicles. Some accessories are to be secured and used within the carwash module 12. Such accessories may include a “photoeye” (not illustrated) for monitoring the vehicle in the tunnel 25 of the carwash module 12 or a directional sign (not illustrated) mounted proximate the carriage 32 to assist persons driving their vehicle into the tunnel 25. In addition, there may be an operational interface (not illustrated) positioned at the entrance of the tunnel 25 to assist the user. Further accessories may be positioned in the equipment module 12, such as a water purifier or softener (not illustrated).

One embodiment of the modular carwash assembly 10 as disclosed herein is fabricated to the inventors' specifications and uses carwash equipment 30 in the tunnel 25 according to the inventors' specification. However, it should be understood that carwash assemblies 10 according to the present invention are not limited to any manufacturer nor are they limited to the precise type of carwash equipment. For example, with regard to the carwash equipment 30, the carwash assembly 10 may comprise a full service tunnel, self-serve, in-dash bay automatic, or fleet/truck wash configuration. Moreover, the carwash equipment 30 may include a touchless washing system or a frictional engagement washing system (e.g., using a cloth brush or nylon bristles) for cleaning vehicles.

Construction of the Carwash Assembly

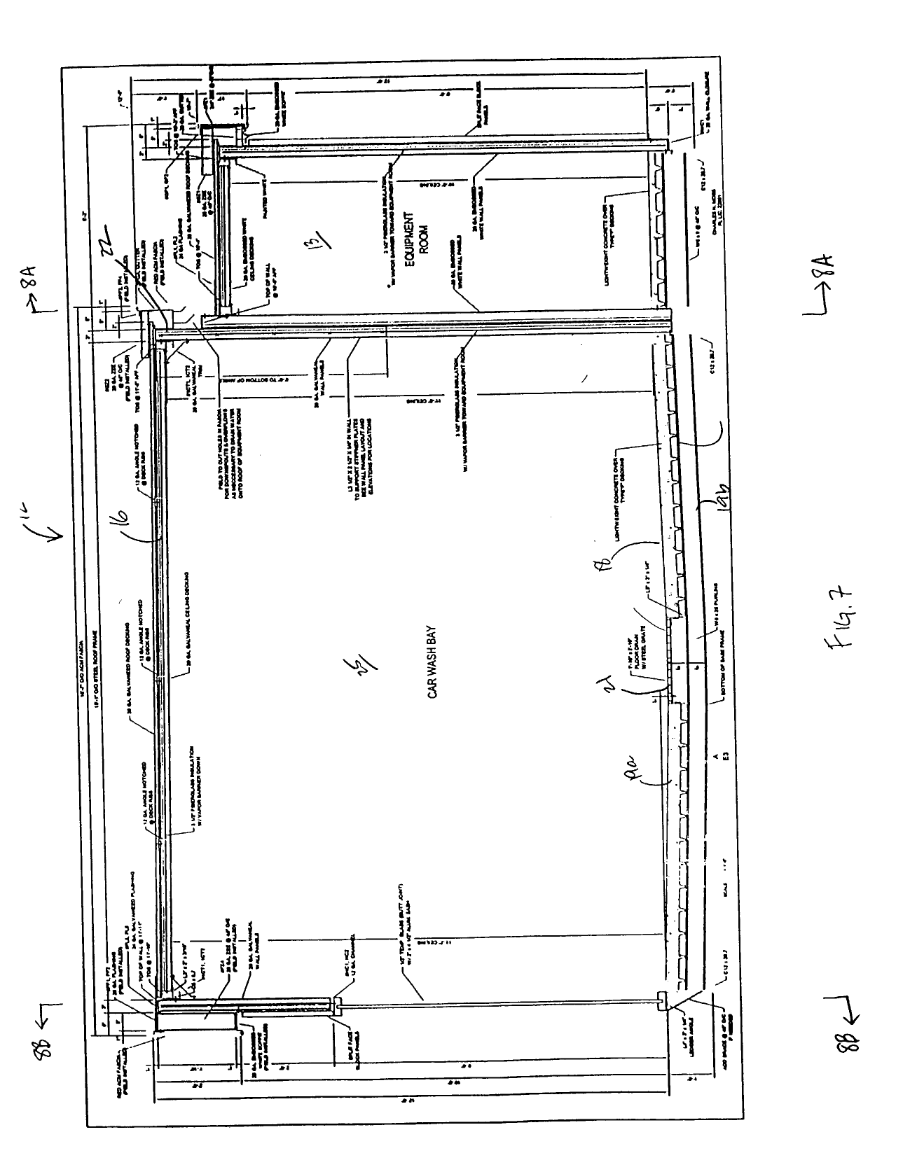

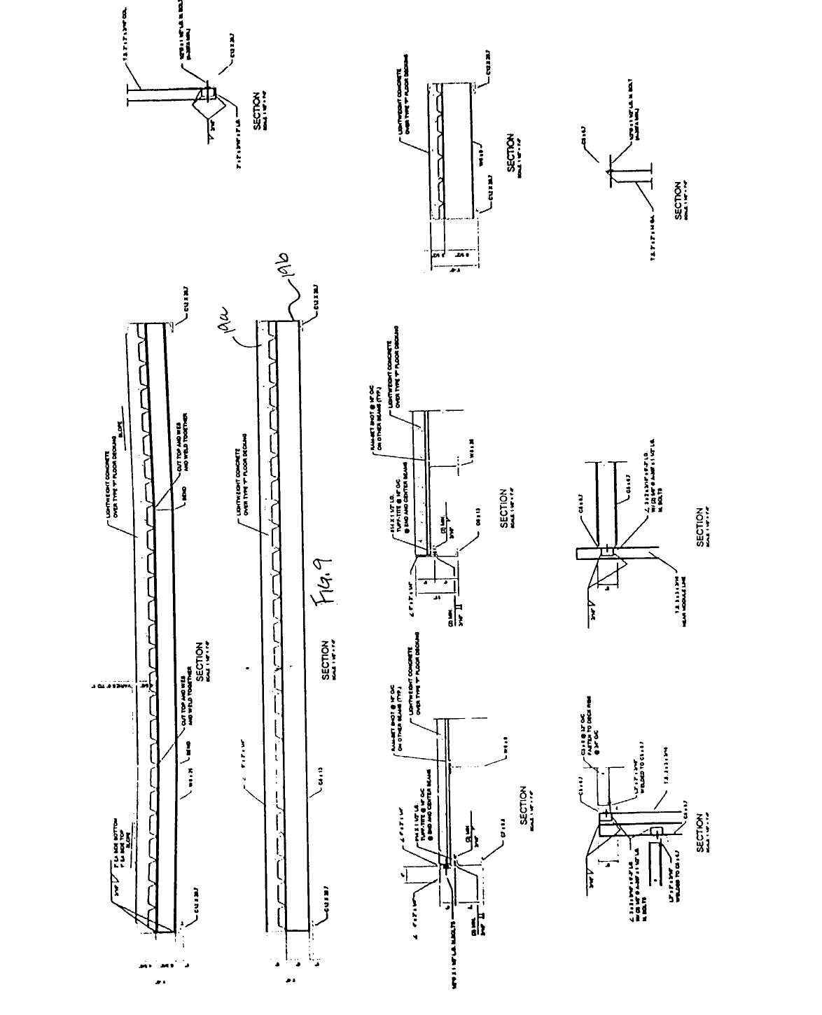

The carwash module 12 and the equipment module 13 of the present invention advantageously are constructed using the various components at a predetermined site and then delivered to the proper location. By producing the modules 12, 13 prior to delivery, the construction on the desired site can be prompt. Looking at FIGS. 7 and 9, the carwash module 12 is advantageously manufactured by first forming a layer 19a, advantageously of lightweight concrete, above a frame 19b (such as an intermediate rib decking) so as to create a sloping floor 18. The various columns 22 of the skeletal system 20 are set in the layer 19a, if layer 19a is concrete, while the concrete hardens. Advantageously layer 19a is angled such that the water will drain to a central location, at which place a grate 21 is placed for the drain. A series of crossarms 24 are used to connect opposing columns 22, on top of which is affixed a roof decking 46.

At least two of the crossarms 24 are mounted on the columns 22 at opposed ends of the carwash module 12. Connected between these two crossarms 24 are two carriage rails 34. The carriage rails 34 support the carriage 32 on carriage wheels 33 rotatably connected to the carriage 32 and driven by the carriage motor. As a result, the carriage motor drives the carriage 32 longitudinally on the carriage rails 34 for the carriage 32 to traverse the tunnel of the carwash module 12.

Operation of the Carwash Assembly

As discussed above, the carwash assembly 10 is separated into the equipment module 13 containing a substantial portion of the carwash equipment 30 and the carwash module 12 which forms the tunnel 25 for receiving the vehicle to be cleaned. Both modules 12, 13 are preferably prefabricated for use together, and these two modules 12, 13 are placed next to each other and coupled together at the construction site. Coupling the two structures 12, 13 together is simple and can be performed in a short period of time relative to the construction of conventional carwash assemblies. While the invention has been shown and described as having two modules or structures, it should be understood that the carwash assembly 10 according to an embodiment of the invention may be formed as one structure or may be formed of more than two structures. For instance, for carwashes having longer tunnels, it is possible that the tunnel portion 27 of the carwash module 12 may be formed using two or more carwash modules 12 coupled together at the site. Two or more modules 12 may also be coupled together in a manner to form multiple bays.

The drawings show a carwash assembly 10 having a superstructure 20 formed with columns, preferably steel columns, 22. These columns 22 form part of a skeletal system 20 that is capable of supporting carwash equipment and other equipment within the tunnel structure 14. In addition to the skeletal system 20, the carwash is also equipped with mounting hardware for enabling the carwash equipment 30 to be mounted to the skeletal system 20. This mounting hardware can take any form. One example provides a series of brackets that are mounted to the walls 14 and to the skeletal system 20 within the walls 14 to support the rails 34 and crossarms 24.

The walls 14 advantageously include protective layer 26, which in this example is shown as fiberglass insulation. While fiberglass is one example of a protective layer, other embodiments of protective layers 26 may be used. Also, while the skeletal system 20 of the preferred embodiment provides the strength necessary to support the carwash equipment 30 through the use of columns 22, other types of supports may be used, as well as other arrangements of supports, and other materials.

Thus, although there have been described particular embodiments of the present invention of a new and useful Prefabricated Modular Carwash Assembly, it is not intended that such references be construed as limitations upon the scope of this invention except as set forth in the following claims.

What is claimed is:

1. A mobile carwash assembly for dispensing fluids onto a vehicle to clean the vehicle, said mobile carwash assembly comprising:
a portable building skeleton having an internal surface and an external surface, said building skeleton being secured by a flooring;
a superstructure attached to said external surface of said building skeleton;
a substantially impervious protective skin connected to said internal surface of said building skeleton; and
washing means for distributing the fluids onto the vehicle, said washing means connected to said building skeleton.

2. The mobile carwash assembly of claim 1 wherein said building skeleton comprises:
a first column pair including a first distal column and a first proximal column, said first distal column and said first proximal column each having a base end and an upper end, wherein said base end of each said column is affixed to said flooring; and
a first crossarm connected between said upper end of said distal column and said upper end of said proximal column.

3. The mobile carwash assembly of claim 2 further comprising:
a second column pair including a second distal column and a second proximal column, said second distal column and said second proximal column each having a base end and an upper end, wherein said base end of each said column is affixed to said flooring;
a second crossarm connected between said upper end of said second distal column and said upper end of said second proximal column;
a pair of carriage rails connected between said first crossarm and said second crossarm;
wherein said washing means is connected to said carriage rails.

4. The mobile carwash assembly of claim 3 further comprising:
a portable equipment housing positioned proximate said building skeleton;
a water pump housed in said equipment housing; and
a conduit connecting said water pump to said washing means.

5. The mobile carwash assembly of claim 4 wherein said washing means comprises:
a carriage mounted to said carriage rails for linear movement on said carriage rails; and
at least one spray arm connected to said carriage;
wherein said spray conduit connects said spray arm with said water pump.

6. The mobile carwash assembly of claim 4 further comprising a motor control unit positioned in said equipment housing, said motor control unit connected to said carriage to control transverse movement of said carriage on said carriage wheels.

7. The mobile carwash assembly of claim 1 wherein said flooring comprises a lightweight concrete.

8. The mobile carwash assembly of claim 1 wherein said washing means comprises a touchless washing system.

9. The mobile carwash assembly of claim 1 wherein said washing means comprises a frictional engagement washing system.

10. A method for installing a modular carwash assembly at a desired location comprising the steps of:
a) constructing a carwash module, including the steps of
pouring a lightweight concrete to provide a sloping floor surface;
mounting a skeletal system to said lightweight concrete, said skeletal system forming a tunnel surrounded by two vertical wall surfaces and a horizontal ceiling surface connected between said two wall surfaces;
mounting two support beams to between said two vertical wall surfaces such that said support beams are substantially perpendicular to said vertical walls;
b) mounting a carriage rail to said support beams;
c) affixing a carriage to said carriage rail, said carriage including means for distributing fluid within said tunnel; and
d) transporting said carwash module to the desired location.

11. The method as described in claim 10, wherein step a) further comprises the step of:
affixing a substantially impervious protective layer to said interior surface of said vertical wall surfaces.

12. The method as described in claim 10, wherein after step d) further comprising the steps of:
constructing an equipment module having a frame affixed to a flooring; and
housing a water pump in said equipment module, said water pump connected to said fluid distributing means.

13. The method as described in claim 12, further comprising the step of:
controlling the transverse movement of said carriage on said carriage wheels using a motor control unit housed in said equipment module.

14. The method as described in claim 12, wherein step d), further comprises the step of:
lifting said carwash module and said equipment module;
moving said carwash module and said equipment module to the desired location; and
connecting said carwash module with said equipment module using a conduit.

15. A modular carwash assembly for cleaning a vehicle, said modular carwash assembly comprising:
a transportable carwash module having a skeletal assembly including
a flooring;
a series of columnar supports having a base end and an opposing supporting end, said base end affixed to said flooring;
a first crossarm and a second crossarm connected between said columns, wherein said first crossarm is substantially parallel to said second crossarm;
a pair of carriage rails connected between said first crossarm and said second crossarm;
a carriage positioned on said carriage rails; and
washing means connected to said carriage for distributing fluid onto the vehicle;
a transportable equipment module positioned proximate said carwash module, said equipment module including a water pump; and
a conduit connecting said water pump with said washing means.

16. The modular carwash assembly as described in claim 15 wherein said carwash module further comprises:
a protective layer connected to said columns of said skeletal system; and
an exterior layer connected to said opposing side of said skeletal system.

17. The modular carwash assembly as described in claim 15 wherein said flooring of said carwash module further comprises:
a lightweight concrete sloping from an apex to a base; and
a drain positioned at said base of said concrete floor;
wherein the water exits the carwash module by flowing through said drain.

18. The modular carwash assembly as described in claim 15 wherein said washing means is a touchless washing system.

19. The modular carwash assembly as described in claim 15 wherein said washing means is a frictional engagement washing system.
